(19) United States
(12) Patent Application Publication
(10) Pub. No.: US 2012/0036501 A1
(43) Pub. Date: Feb. 9, 2012

(54) Method and System for Capturing System and User Events Using Hardware Trace Devices

(76) Inventors: Tomas Evensen, Foster City, CA (US); Felix Burton, San Mateo, CA (US)

(21) Appl. No.: 12/849,393

(22) Filed: Aug. 3, 2010

(51) Int. Cl. G06F 9/44

(52) U.S. Cl. 717/128

(57) ABSTRACT

A method including creating a storage buffer in a portion of memory of a computing device; inserting an instrumentation point in software of a further computing device, the instrumentation point corresponding to an event monitored by a hardware trace device, data corresponding to the event being stored in the storage buffer; executing the software; and processing the data, wherein the data is processed after a completion of the execution of the code.

### BACKGROUND

When developing software (e.g., applications, drivers, functions, etc.) for hardware devices, developers typically run the software as it is being developed on the hardware device to determine a variety of information about the software under development. This information may include, for example, if the software is running properly, if it is running at desired speed, if it is interacting properly with other hardware and software on the device, etc. This information may be determined by logging events that occur while the software is executing. The events may be any occurrence that is initiated by the software, such as component entry and exit, function calls, software execution states, message communications, resource usage, etc. Developers use this event logging to determine the information they desire about the software under development.

### SUMMARY OF THE INVENTION

A method including creating a storage buffer in a portion of memory of a computing device; inserting an instrumentation point in software of a further computing device, the instrumentation point corresponding to an event monitored by a hardware trace device, data corresponding to the event being stored in the storage buffer; executing the software; and processing the data, wherein the data is processed after a completion of the execution of the code.

A computing system includes a processor, a memory and a hardware trace device. The memory includes a dedicated storage buffer. The hardware trace device monitors an instrumentation point within a further computing system. The hardware trace device is configured to store data in the storage buffer during an execution of code by a processor of the further computing system. The data is processed after a termination of the execution of the code.

### BRIEF DESCRIPTION OF THE DRAWINGS

FIG. 1 shows an exemplary system including an exemplary target device and an exemplary host computer.

FIG. 2 shows an exemplary method for logging system and user events.

### DETAILED DESCRIPTION

The exemplary embodiments may be further understood with reference to the following description and the appended drawings, wherein like elements are referred to with the same reference numerals. The exemplary embodiments describe systems and methods for efficiently capturing system and user events using hardware trace devices.

Computing systems may use software instrumentation in order to log events that are occurring within the system. Typically, a recorded event includes an event identifier, zero or more event-specific arguments, and a time stamp. The information is typically written into a memory-based log buffer, and subsequently either uploaded to a host computer or processed in an application on the target system. Writing an event into the log buffer may typically require tens or hundreds of instructions. Subsequently uploading the event to the host computer, while often accomplished by a low-priority task or process, typically involves networking (e.g., TCP/IP), and therefore takes tens of thousands of instructions.

The uploading process, in particular, may create additional system events, thus muddling the information provided by the events being uploaded. The additional overhead created by uploading event logs to the host system, or processing the same events on the target system, makes it difficult to obtain an accurate picture of the events occurring on the target system. This is particularly problematic with regard to system events that are very frequent, for which logging is more prone to skew the resulting data. That is, the act of logging events within the software application may lead to a fundamental change in the operating characteristics of the software application.

The exemplary embodiments present systems and methods for logging events in a manner that avoids the problems described above. In most cases, the exemplary embodiments may require only a small number of instructions to generate events, and further generate no side events due to uploading or further processing of events.

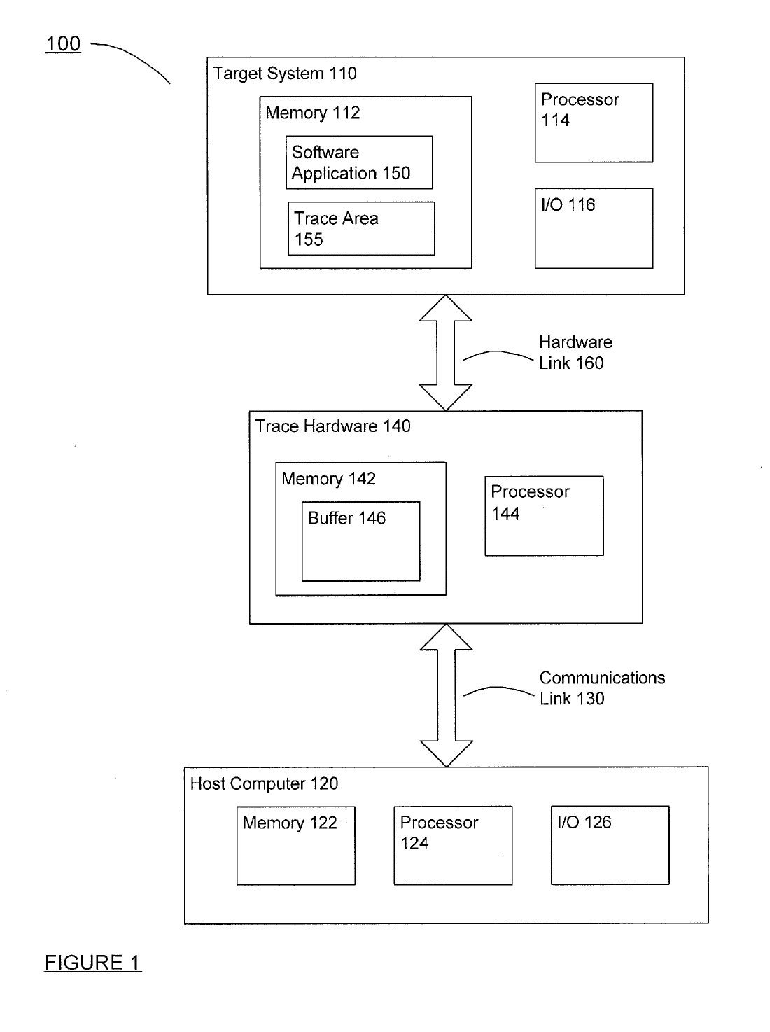

FIG. 1 illustrates an exemplary system 100. A target system 110 generates events to be logged, as described above. The target system 110 may be, for example, an embedded computing system, a mobile computing system, or any other computing system for which it is desirable to efficiently generate event logs. The target system 110 may include a memory 112 storing an operating system and various other programs embodied in code. The target system 110 may also include a processor 114, which may be capable of executing the operating system and the various other programs stored by the memory 112. The target system 110 may also include input/output (“I/O”) 116, which may include, e.g., a display, a keyboard, a mouse, a touchpad, or various other mechanisms by which a developer may input instructions to the target system 110. The memory 112 of the target system 110 may store a software application 150 to be monitored by the exemplary embodiments. Thus, in this example, the software application 150 may be considered to be the software under development for which a developer desires to log events. The memory 112 of the target system 110 may also include a trace area 155, which may be used to store trace data as described below.

The system 100 may also include a host computer 120. Like the target system 110, the host computer may also include a memory 122, a processor 124, and an I/O 126. The host computer 120 may be used to develop, debug, and analyze programs for use on certain types of target systems 110, such as embedded or mobile computing devices.

The system 100 may also include exemplary trace hardware 140. The trace hardware 140 may include a memory 142 and a processor 144. The memory may store a trace buffer 146, which will be described in, further detail herein. The trace hardware 140 may be linked to the host computer 120 by a communications link 130, which may be any type of wired or wireless communications link capable of transmitting data between the target system 110 and the host computer 120. In one exemplary embodiment, the communications link 130 may be a link over the Internet using the TCP/IP communications protocol. The trace hardware 140 may also be linked to the target system 110 by a hardware link 160. In one embodiment, the hardware link 160 may be a set of dedicated pins on a CPU of the target system 110 which may be directly connected to the trace hardware 140. This may be, for example, JTAG, BDM, Aurora, Nexus, etc. This hardware connection to the target system 110 may enable the trace hardware 140 data to directly and autonomously record data from the target system 110.

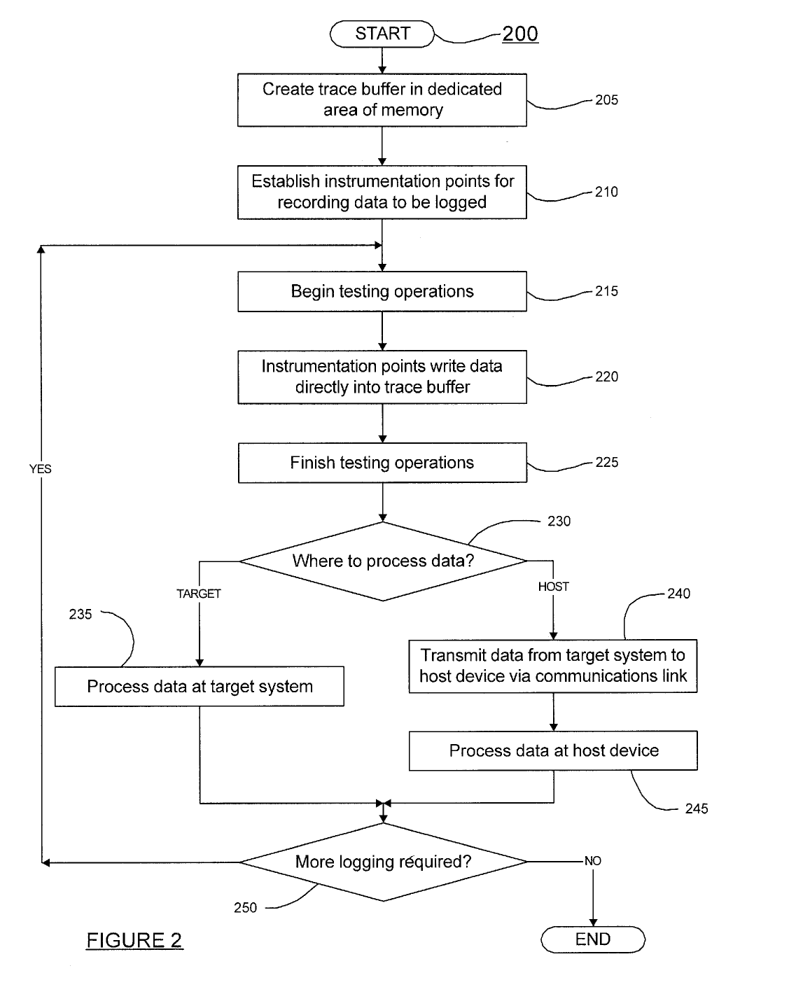

FIG. 2 illustrates an exemplary method 200 for logging events on a target system, such as the target system 110 of FIG. 1. The exemplary method 200 will be discussed with reference to the components of the exemplary system 100, though those of skill in the art will understand that various other combinations of hardware and software may also be capable of operating in accordance with the exemplary method 200. In step 205, a segment of the memory 112 of the target system 110 is dedicated to form a trace area 155. This may be accomplished using standard memory management techniques that are known in the art.

In step 210, one or more hardware trace connections are inserted in the form of desired instrumentation points. Instrumentation points may be considered to be code that is inserted into an application that is not for the purpose of the intended use of the application, but is for the purpose of developing the application (e.g., debugging). The instrumentation points are placed in locations of the application code corresponding to an event that the developer desires to log. For example, if the event that is to be logged is the entry of a function, an instrumentation point may be inserted at a location where the function call is made or at the beginning of the execution of the function. In traditional software event logging, the instrumentation point may include a print statement so that when the event occurs, the system will print the predetermined statement to the log to inform the developer that the event occurred and when it occurred. However, the act of executing the print statement or other code associated with the instrumentation point may fundamentally alter the execution or timing of the application, thereby not providing the correct or complete information to the developer. The instrumentation point of the exemplary embodiments has little overhead and therefore does not suffer from these defects. An exemplary instrumentation point will be described below.

Thus, in step 210 the developer inserts the desired instrumentation points in the software, such as the kernel of the target system 110, the hypervisor of the target system 110, an application running on the target system 110 (e.g., the software application 150), etc. As described above, in this example we are considering the software application 150 as the instrumented software, but the instrumentation points are not limited to the software application 150. The following represents exemplary instrumentation point code:

| event_trace.h: | |
|---|---|
| | struct trace_area { |

TASK_ID currentTask;
TASK_ID taskCreate;
TASK_ID taskDelete;
SEM_ID semTake;
SEM_ID semGive;
...

| | }; |
|---|---|
| | #define eventTrace(EVENT, VALUE) \ |
| | (((volatile struct trace_area |
| | *)TRACE_AREA_BASE_ADDR)− |
| . | >EVENT = VALUE) |
| semaphore.c: | |
| | #include “event_trace.h” |
| | ... |
| | void semTake(SEM_ID id, ...) { |

...
eventTrace(semTake, id);
...

}
...
void semGive(SEM_ID id, ...) {

...
eventTrace(semGive, id);
...

}

As can be seen from the above exemplary instrumentation point code, the instrumentation point requires very little code and the execution overhead is very small compared to a standard software-based instrumentation point. Specifically, the above exemplary instrumentation point can be executed by the processor 114, and written to the buffer 146 of the trace hardware 140 via the hardware link 160. A hardware trace, such as a JTAG (Joint Test Action Group) trace device, can thus capture each write access into the trace buffer. This information may include address written to, data written and time of writing. This data may then be processed as described in greater detail below. It should be noted that the exemplary embodiments are not limited to JTAG trace devices, but may be any type of hardware trace device.

In step 215, a user (e.g., a user of the target system 110, a software developer developing a program such as the software application 150 for the target system 110, etc.) performs tasks to be logged by the hardware traces. This may involve utilizing the target system 110, executing the software application 150, or performing any other tasks that may generate events to be logged. While this occurs, in step 220 the hardware traces record data in the buffer 146. In one embodiment, the hardware traces may record memory write accesses (e.g., address written to, data written, time of write access) into the buffer 146. However, those of skill in the art will understand that any type of event information may be recorded. Subsequently, in step 225 actions to be logged finish, and thus recording also finishes.

In step 230, the location where the data recorded in step 220 will be processed is determined. It will be apparent that, rather than making the determination during the course of the exemplary method 200 (e.g., after data has been recorded), this location may be predetermined based on the nature of the target system 110, the nature of the software application 150, the interests of the software developer or other user, etc. If the data in the buffer 146 is to be processed on the target system 110, then in step 235 this processing occurs. Alternately, if data is to be processed on the host device 120, then in step 240 the data in the buffer 146 is transmitted to the host device 120 via the communication link 130, and in step 245 the data is processed. Data processing may include any type of operation on the trace data. For example, the event data may be formatted or correlated in a specific matter, certain information may be directly or indirectly determined from event data, the data may be filtered, etc. This processed data may then be presented to the developer to provide information concerning the operation of the software application 150 on the target system 110. Subsequently, in step 250, if another test is desired then the method returns to step 215; if no more testing is desired, the method terminates.

The use of hardware traces and a dedicated area of memory may drastically reduce the overhead required to record system events, requiring only a small number of instructions rather than the hundreds or thousands required by prior techniques. Thus, the recorded results may not be influenced by the execution of instructions required to transmit and/or process the records. Specifically, as described above, when using the typical software-based logging mechanism, the processor 114 needs to execute the instructions associated with the software-based logging mechanism. This execution not only takes up processor time and adds overhead to the program execution, but it possibly adds additional events or modifies events, making it more difficult to determine what is happening on the target system 110. However, as can be seen in the exemplary embodiments described above, the hardware-based trace method does not add any significant overhead to the execution of the target system 110 because the exemplary embodiments simply use a write instruction to the trace buffer 140 without any additional overhead required.

Further, because the overhead involved is so low, it may not be necessary to dynamically enable and disable the various instrumentation points, simplifying the work to be done by a software developer. Again, in prior software-based solutions, the overhead associated with each instrumentation point requires the developer to selectively enable and disable instrumentation points, because if all instrumentation points were enabled, the amount of processing time and power used to simply record all the events would overwhelm the target system 110. However, in the exemplary embodiments, because the overhead is so low, all instrumentation points can be enabled at the same time and all the corresponding events can be recorded. This saves the developer the time of having to enable and disable instrumentation points each time the developer desires to execute the software application 150 and log events during the execution. Thus, each time the software application 150 is executed, the hardware trace method of the exemplary embodiment may provide a complete log of events from all enabled instrumentation points. A filter may be applied to the events to filter out those events that are not of interest to the developer. However, such a filter could be applied globally to the results, rather than individually enabling and/or disabling instrumentation points, thereby saving developer time. Finally, it should be noted that it is possible to disable the trace at compile time so that the final version of the software application 150 has the instrumentation points disabled.

Thus, because so few instructions are required in the exemplary embodiments, it may be possible to trace very short-lived events, such as packet forwarding and the operation of spinlocks, without seriously affecting performance of the software application 150 on the target system 110. This may enable a software developer to have an improved understanding of the behavior of the target system 110 when executing the software application 150. Further, because logging is accomplished mainly by a hardware connection to the target system 110,

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A method, comprising:
creating a storage buffer in a portion of memory of a computing device;
inserting an instrumentation point a software application, the instrumentation point corresponding to an event monitored by a hardware trace device, data corresponding to the event being stored in the storage buffer;
executing the software; and
processing the data.

2. The method of claim 1, wherein the data is processed by a software application stored in the memory of the computing device.

3. The method of claim 1, further comprising:
transmitting the data from the computing device to a further computing device.

4. The method of claim 3, wherein the data is processed by a further software application stored in a memory of the further computing device.

5. The method of claim 1, wherein the hardware trace device is a JTAG hardware trace device.

6. The method of claim 1, wherein the data relates to a write access caused by the execution of the instrumentation point.

7. The method of claim 6, wherein the data includes an address written to, a time of writing, and a record of the data written.

8. The method of claim 1, wherein the portion of the memory is a dedicated portion of the memory.

9. The method of claim 1, wherein the software is one of a kernel of the computing device, a hypervisor of the computing device, and an application of the computing device.

10. The method of claim 1, wherein the data is processed one of after a completion of the execution of the software and during the execution of the software.

11. A computing system, comprising:
a processor;
a memory including a dedicated storage buffer; and
a hardware trace device monitoring an instrumentation point within a further computing system, the hardware trace device being configured to store data in the storage buffer during an execution of code by a processor of the further computing system.

12. The computing system of claim 11, wherein the memory stores processing software, and wherein the data is processed by the processor by executing the processing software.

13. The computing system of claim 11, further comprising:
a communications link, wherein the data is transmitted to a further device via the communications link, wherein the data is processed by the further device.

14. The computing system of claim 11, wherein the hardware trace device is a JTAG hardware trace device.

15. The computing system of claim 11, wherein the data stored by the hardware trace relates to an execution of code by the computing system.

16. The computing system of claim 15, wherein the data stored by the hardware trace relates to a write access caused by the execution of code.

17. The computing system of claim 16, wherein the data includes an address written to by the write access, a time of the write access, and a record of the data written.

18. The computing system of claim 11, wherein the instrumentation point is created in one of a kernel, a hypervisor and an application stored in the memory.

19. The computing system of claim 11, wherein the data is processed one of after a termination of the execution of the code and during the execution of the code.

20. A non-transitory computer readable storage medium storing a set of instructions executable by a processor, the set of instructions being operable to:
create a storage buffer in a portion of memory of a computing device;
insert an instrumentation point a software application, the instrumentation point corresponding to an event monitored by a hardware trace device, data corresponding to the event being stored in the storage buffer;
execute the software; and
process the data.
